(19) United States
(12) Patent Application Publication
(10) Pub. No.: US 2018/0242708 A1
(43) Pub. Date: Aug. 30, 2018

(54) APPARATUS, METHODS, AND SYSTEMS FOR ELECTRONIC ARTIFICIAL NAIL

(71) Applicants: Gregor Felzer, Slovenska Bistrica (SI); Amor Chowdhury, Kamnica (SI); Dalibor Igrec, Maribor (SI)

(72) Inventors: Gregor Felzer, Slovenska Bistrica (SI); Amor Chowdhury, Kamnica (SI); Dalibor Igrec, Maribor (SI)

(21) Appl. No.: 15/697,403

(22) Filed: Sep. 6, 2017

(30) Foreign Application Priority Data
Feb. 28, 2017 (SI) P-201700068

(51) Int. Cl. A45D 31/00; G06F 3/147; G09G 5/39

(52) U.S. Cl. CPC A45D 31/00; G06F 3/147; G09G 5/39; G09G 2354/00; G09G 2360/08; G09G 2310/061; G09G 2370/16

(57) ABSTRACT

An artificial electronic nail made of a stack of thin layers, the stack having a shape of an artificial nail and including a first top thin layer having an electronic display facing upward, such that, when content is displayed by the electronic display, the content is visible from above the first top layer, a second thin layer having a contactless module having an antenna and being configured for contactless communication with a smart electronic device and a third thin layer having a central processing unit (CPU) connected to the contactless module and the electronic display and storing processor-executable instructions on a non-transitory processor-readable memory of the CPU that when executed by the CPU enables the artificial electronic nail to change its appearance and to perform various contactless communications with the smart electronic device.

### CROSS-REFERENCE TO RELATED APPLICATIONS

This application claims the benefit of Slovenian Application No. P-201700068, filed Feb. 28, 2017, which is hereby incorporated by reference, to the extent that it is not conflicting with the present application.

### BACKGROUND OF INVENTION

### 1. Field of the Invention

The invention relates generally to electronic technology and more particularly to electronic artificial nails and methods of using the same.

### 2. Description of the Related Art

Users who wish to decorate or color their fingernails and/or toenails may find the process difficult and time-consuming. The removal of nail polish is difficult, and many nail polish removers contain acetone, which is highly flammable, and thus, can be dangerous. The process of applying new nail polish and waiting for the polish to dry can also be time-consuming. Artificial nails or gel nails may also be applied instead, but these processes may also be difficult, time-consuming, costly, and require assistance from others. Users who desire different looks of their nails may find that these problems prevent more frequent changing of the nail color or appearance. Some users may also wish for their nail appearance to be dynamic, or provide another function in addition to aesthetics. Users may also need a quick, convenient, and easy means of retrieving biometric information from a wearable accessory or technology that does not fall off and is not bulky and does not hinder movement. Thus, there is a need for new and improved apparatus, system and methods that provide a solution to these problems.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, an artificial electronic nail is provided, the artificial electronic nail being made from a stack of thin layers, the stack having a shape of an artificial nail and including a first top thin layer having an electronic display facing upward, such that, when content is displayed by the electronic display, the content is visible from above the first top layer, a second thin layer having a contactless module having an antenna and being configured for contactless communication with a smart electronic device and a third thin layer having a central processing unit (CPU) connected to the contactless module and the electronic display and storing processor-executable instructions on a non-transitory processor-readable memory of the CPU that when executed by the CPU enables the artificial electronic nail to change its appearance and to perform various contactless communications with the smart electronic device. Thus an advantage is that a user has an easy, convenient, fast and versatile way to change the appearance of her artificial nail, to match for example her outfit.

In another aspect, an artificial electronic nail is provided, the artificial electronic nail including a protective housing having a shape of an artificial nail and having a top surface, a bottom surface and a hollow space between the top and bottom surfaces; an electronic display disposed within the hollow space such that, when content is displayed by the electronic display, the content is visible from above the top surface, thus customizing the artificial electronic nail's appearance; a contactless module comprising an antenna and being configured for contactless communication with a smart electronic device; a central processing unit (CPU) connected to the contactless module and the electronic display and storing processor-executable instructions on a non-transitory processor-readable memory of the CPU that when executed by the CPU enables the artificial electronic nail to perform operations including: detecting that power is available to the CPU; causing the content to be stored on the memory of the CPU; causing the content to be displayed via the electronic display; detecting that the smart electronic device is within a range of contactless communication with the artificial electronic nail; initiating contactless communication between the smart electronic device and the artificial electronic nail; and allowing the CPU to write to or read from the smart electronic device artificial electronic nail data.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the perspective view of an electronic nail, according to an aspect.

FIG. 2 illustrates a step of an exemplary method of attaching an electronic nail to a user's natural nail according to an aspect.

FIG. 3 illustrates another step of an exemplary method of attaching an electronic nail to a user's natural fingernail, according to an aspect.

FIGS. 4A-4B illustrates the side sectional view and the top perspective view, respectively, of the layers of an electronic nail without an integrated power source, according to an aspect.

FIGS. 5A-5B illustrates the side sectional view and the top perspective view, respectively, of the layers of an electronic nail with an integrated power source, according to an aspect.

FIG. 5C illustrates a diagrammatic view of another example of the layers of the electronic nail, according to an aspect.

FIG. 6 illustrates a schematic view of the electronic and other components of the electronic nail, according to an aspect.

FIG. 7 illustrates a schematic view of the user's experience with an electronic nail's content switch and upload system using a contactless communication means, according to an aspect.

FIG. 8 illustrates a flow chart depicting the steps of a software process for an electronic nail, according to an aspect.

FIG. 9 illustrates a flow chart depicting the steps of a software process for an electronic nail, without an integrated thin electric battery, according to an aspect.

FIG. 10 illustrates a flow chart depicting the steps of a user's experience while using the software of the electronic nail, according to an aspect.

### DETAILED DESCRIPTION

What follows is a description of various aspects, embodiments and/or examples in which the invention may be practiced. Reference will be made to the attached drawings, and the information included in the drawings is part of this detailed description. It should be understood that, for clarity of the drawings and of the specification, details about structural components or steps that are known in the art are not shown or described if they are not necessary to understand the invention. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

For the following description, it can be assumed that most correspondingly labeled elements across the figures (e.g., 500 and 600, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

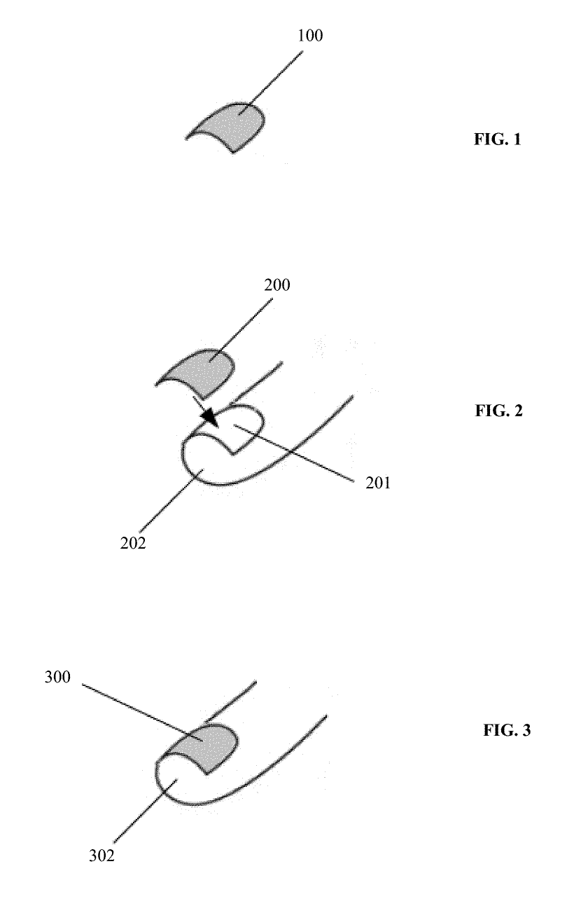

FIG. 1 illustrates the perspective view of an electronic nail (“electronic nail,” or “smart nail”) 100, according to an aspect. The smart nail 100 may provide still or moving images and may be affixed on a user's fingernail. The images may, for example, provide any suitable colors, hues, patterns, figures, or images. The smart nail 100 may be provided in a variety of different shapes, sizes, and thicknesses. The contactless communication features or capabilities of the smart nail 100, beside uploading content, may also be used for any suitable purpose, through near-field communication (NFC) or radio frequency identification (RFID) for example, such as for user identification and contactless payment, for example. In other examples, the smart nail 100 may be used as a fashion accessory, and may also be used for medical purposes, such as, for example, as a nail replacement for users that may have suffered injury to their real nails, such that any damage or discoloration may be hidden. The smart nail 100 may also be configured to be worn as a wearable tracker of biometric data (e.g., such as temperature, heart-beat, the nail having the respective sensors) while also serving as a fashion accessory, or may be a plain, uncolored nail worn as a biometric data tracker. The smart nail 100 as a tracker may be for the user's interest or for medical purposes. An advantage may be that the smart nail 100, while providing utility, may be colorful or discreet according to the user's needs.

FIG. 2 illustrates step 1 of an exemplary method of attaching a smart nail 200 to a user's natural nail 201, showing the top perspective view of aligning a smart nail 200 with a user's natural nail 201, according to an aspect. The smart nail 200 may be affixed to a fingernail 201 of a user's finger 202 as shown, or may be affixed to a user's toenail, for example. The method of attaching a smart nail 200 to a user's natural nail may be similar to known procedures for attaching other similar artificial nails, for example.

FIG. 3 illustrates step 2 of an exemplary method of attaching a smart nail 300 to a user's natural nail, showing the top perspective view of a smart nail 300 applied to a user's natural fingernail, according to an aspect. The smart nail may be applied to the natural nail of a user's finger 302 or toe. The smart nail 300 may be configured to fit the nail location or may be provided in a variety of sizes to fit a user's natural nail and/or preferences. The application of the smart nail 300 to the natural nail may be performed by using adhesives, for example.

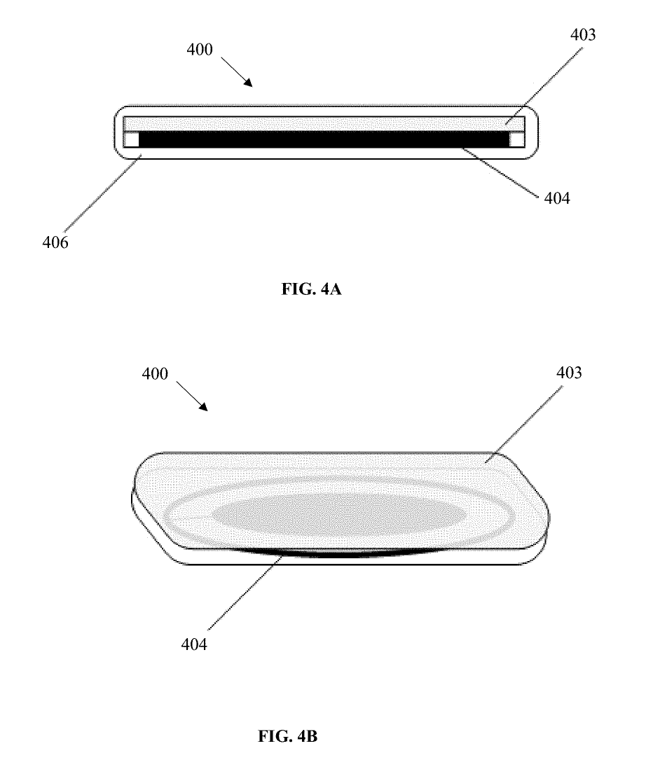

FIGS. 4A-4B illustrates the side sectional view and the top perspective view, respectively, of the layers of a smart nail 400 without an integrated power source, according to an aspect. As an example, a smart nail may be provided without a power source, and may be provided with parts stacked into thin layers. As an example, the smart nail may include an electronic display 403 and an electronic module 404 comprising an antenna and electronic components for sending and receiving data contactless/wirelessly and/or other functions described herein. The smart nail may also include a protective covering or housing 406, having a preferably transparent top surface. The display 403 may, for example, be the uppermost layer furthest from the user's natural nail, such that any decorative elements or images provided and/or displayed by the smart nail 400 may be visible to the user. The electronic module 404 may, for example, be used for contactless communications and/or non-contact power transfer. As an example, a smart nail 400 without an integrated power source may display decorative elements or images using e-ink technology or any other similar suitable technology, such that the displayed content may remain visible even after an external power source is removed. Connection to an external power source may thus only be needed at the time of changing the display or sending or uploading data, and may be provided by, for example, the magnetic field of a smart electronic device, such as a mobile device, in close proximity or in range of the smart nail to act as a non-contact power source, for example. The range of the connection between the smart nail and the non-contact power source may vary according to the models and types of electronic devices used. Typically, non-contact power and wireless communication may range a few centimeters. For example, for the NFC standard including non-contact power the range may be up to 4 (four) centimeters (cm).

Again, the layers of the smart nail 400 may all be encapsulated into a housing 406 (not shown in FIG. 4B for visual clarity), which may be compact, airtight, and waterproof. The housing 406 may be able to be mounted, attached, or affixed to a user's nail, and may be configured to allow the passing of contactless communications with a smart electronic device. The housing 406 may also protect the electronic components of the smart nail 400, which may be sensitive and require airtight and watertight protection, and the housing 406 may also protect the electronic components from physical damage. In order to provide a perfect fit onto a user's natural nail, the housing 406 may be trimmed, filed, sanded, or cut before use.

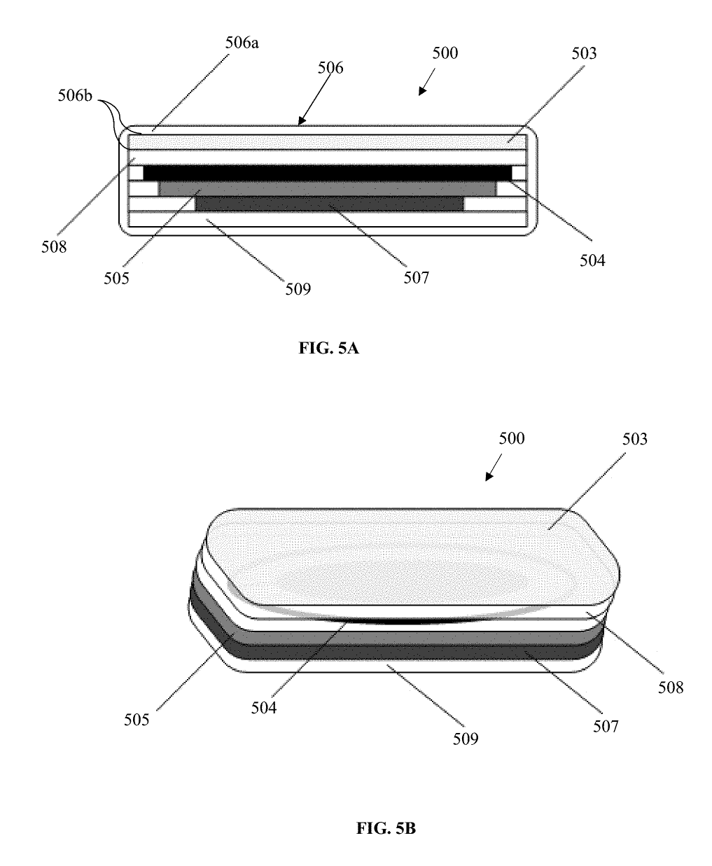

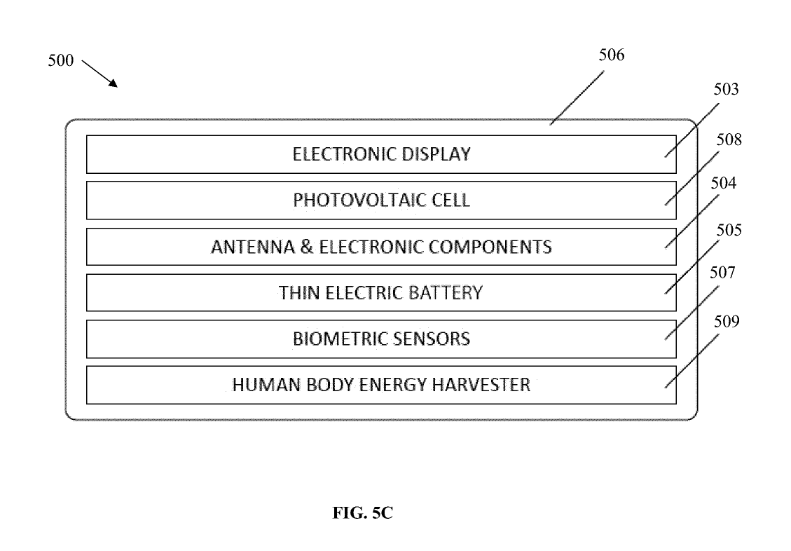

FIGS. 5A-5B illustrates the side sectional view and the top perspective view, respectively, of the layers of a smart nail 500 with an integrated power source, according to an aspect. The smart nail 500 layers may be, for example, an electronic display 503, a photovoltaic cell 508, an electronic module 504, a thin electric battery 505, biometric sensors 507 (e.g., temperature sensor, infrared (IR) heart rate sensor, etc.), a human body energy harvester 509, and a housing 506 (not shown for visual clarity in FIG. 5B). As an example, the simplest human body energy harvester that may be used is piezo electric element that converts motion/acceleration to electricity. As another example, a thermoelectric generator, which is solid state device that converts heat flux into electrical energy, may be used. Heat flux is generated by temperature difference between body and smart nail which is exposed to environment.

Again, the housing 506 may be able to be mounted, attached, or affixed to a user's nail, and may allow the passing of contactless communications with a smart electronic device. Again, the housing 506 may protect the electronic components of the smart nail 500, which may be sensitive and require airtight and watertight protection, and the housing 506 may also protect the electronic components from physical damage. The housing 506 (406 in FIG. 4) can be sanded or trimmed till a permissible limit such that resulting customized shape of the smart nail 200 fits suitably to the real nail 201 and get a good final appearance, while at the same time electronic display 503, control-communication electronics with antenna 504 and the other components don't lose the functionality described herein, including the electronic display 503 displaying the content to its very edges, to achieve for example the artificial nail look. This may be possible by for example adopting a structural configuration as suggested in FIG. 5A in which the display 503 and all the other components are smaller than the housing 506, such that at most they reach only to the internal edges 506b of the housing 506, and in which the top visible housing layer 506a acts as lens. This lens 506a makes the display 503 shove content to the very edges of the top layer 506a and thus to the very edges of the housing 506 that are visible after the mounting of the smart nail 500 as an artificial nail. This way, the housing 506 (406 in FIG. 4) allows small trimming, potentially up to the thickness of the housing's walls.

FIG. 5C illustrates a diagrammatic view of another example of the layers of the smart nail, according to an aspect. Again, as an example, the smart nail may include a plurality of thin (e.g., up to few 100 μm) and stacked layers, such as an electronic display 503, a photovoltaic cell 508, an antenna and other associated electronic components 504, a thin electric battery 505, biometric sensors 507, and a human body energy harvester 509. It should be understood that, photons could reach the photovoltaic cell 508 by for example configuring the display 503 such that it is not fully covered with wiring and internal elements, so photons can pass through and reach the photovoltaic cell 508 to generate power. The biometric sensors 507 may measure biometric parameters such as the user's temperature and heart rate. The display 503 may display still or moving content, and may, for example, be e-ink, LED, OLED, or any other suitable type of electronic display. As an example, the smart nail 500 may be provided with an electronic display 503 and electronic module 504 that are powered by the thin battery 505 which may be charged by a photovoltaic cell 508, which in turn may collect energy from sunlight. The human body energy harvester 509 may also serve as a power source or may help to charge the thin electric battery 505, and may derive energy or power from the user's heat, blood flow, chemical processes, and so on. Again, the electromagnetic field of an external smart electronic device may also act as a non-contact power source, and may help to charge the thin electric battery 505 when in proximity to the smart nail 500.

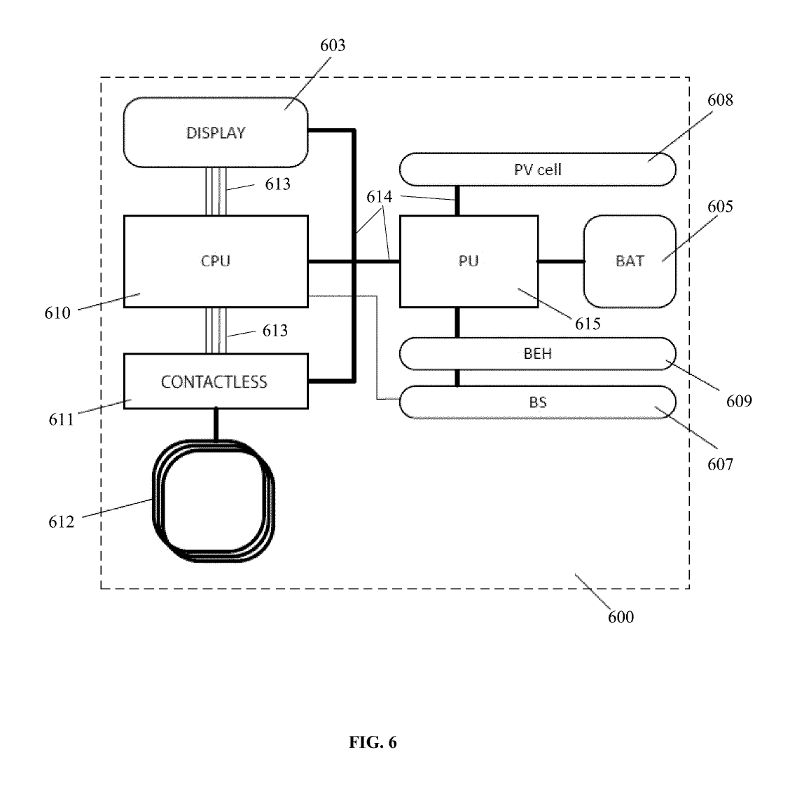

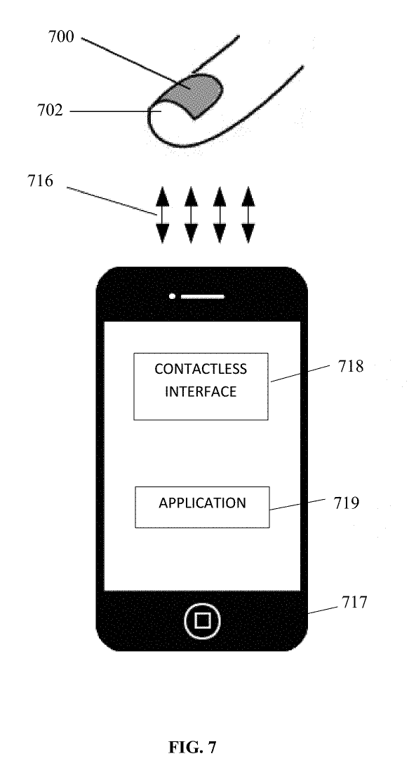

FIG. 6 illustrates a schematic view of the electronic components of the smart nail 600, according to an aspect. A power unit (PU) 615 may be provided within the smart nail 600 for power distribution via power lines 614, for example, to the other electronic components of the smart nail 600. The power unit 615 may use the thin electric battery (BAT) 605 and/or the photovoltaic cell (PV) 608 as sources of electric power. The power unit 615 may also be used for charging the thin electric battery 605 by using several sources, such as the photovoltaic cell 608, the human body energy harvester (BEH) 609, and the electromagnetic field (not shown) of an external device such as a smart electronic device. The external charging device may act as a non-contact power source and may communicate with the contactless antenna 612, trough, for example, near-field communication or any other suitable means of communication. The human body energy harvester 609 may collect energy from body heat, body chemicals, blood flow, body movements, and so on. The body movements may include tiny body movements and energy may be collected using microelectronics, and piezoelectric and nanoscale devices, as known in the art. A central processing unit (CPU) 610 may also be provided, and may act as the core component connected with the contactless module 611, sensors 607, and the electronic display 603 via signaling lines 613, for example. The CPU 610 may include components and modules (not shown for drawing clarity) known in the art and necessary for enabling the CPU to perform the functions described herein. Such components and modules may include memory, CPU clocks, timers, input/output ports, communication ports, contactless controller and display controller. The CPU 610 may contain custom-built software or logic with algorithms to talk and exchange data with the display 603 for displaying and changing visual content, reading biometric sensors at predetermined or preset intervals, and may also store data and communicate with a smart electronic device, or any other means of communication using the contactless module 611 and the antenna 612. For the production of the electronic display 603, the antenna 612 for contactless communication and for non-contact power transfer with additional electronic components, photovoltaic cell 608, and sensors for measuring biometric parameters 607, the technology for manufacturing integrated circuits may be utilized, as an example. The technology may enable the production of the smart nail's layers in small and thin enough dimensions such that the final smart nail product may comfortably and esthetically fit onto the size and shape of a user's natural nails of a hand or foot.

FIG. 7 illustrates a schematic view of the user's experience with a smart nail's content switch and upload system using a contactless communication means, according to an aspect. The communication may take place by interaction with a smart electronic device 717, for example. The smart electronic device 717 may be a smart phone, tablet, mobile device, or any other suitable device with internet connectivity features and needed functionality as described herein. The user may use the smart electronic device 717 to select content, such as, for example, still or moving images. The selected content may be the same for all smart nails 700 worn by the user, or may differ between individual smart nails 700. The user may select desired content by using a smartphone or web-based application 719, for example. The application 719 may allow the user to select content from a web portal, a web content store, or from the user's personal archive. As an example, when content is selected, the user may move their worn smart nail 700 within close proximity to the smart electronic device 717, such that the selected content may be transferred to the smart nail 700 by contactless communication protocols 716 (e.g., NFC) between the contactless interface 718 of the electronic device 717 and the antenna 612 of the smart nail 600, 700. A user may wear a smart nail 700 on each natural nail, and each smart nail may be provided with its own unique identification number, which may allow for switching or uploading content to each smart nail individually with transfer of communication 716 to all smart nails worn by the user on the hands and/or feet. During the communication transfer 716 for content switching or upload, biometric sensor data or any other suitable data may also be downloaded to the electronic device 717. The received data may then be available for further use or processing. The artificial electronic nail 700 may be configured such that an electromagnetic field 716 from the smart electronic device 717 may be used as an electric power supply for changing the content to be displayed via the electronic display 503. Thus, in this example, the need for a battery may be eliminated. Again, the artificial electronic nail 700 may have a unique identification number, which may be used to identify the smart nail for content selection in application 719 and to address the smart nail during content upload/download during contactless communication with the contactless interface 718.

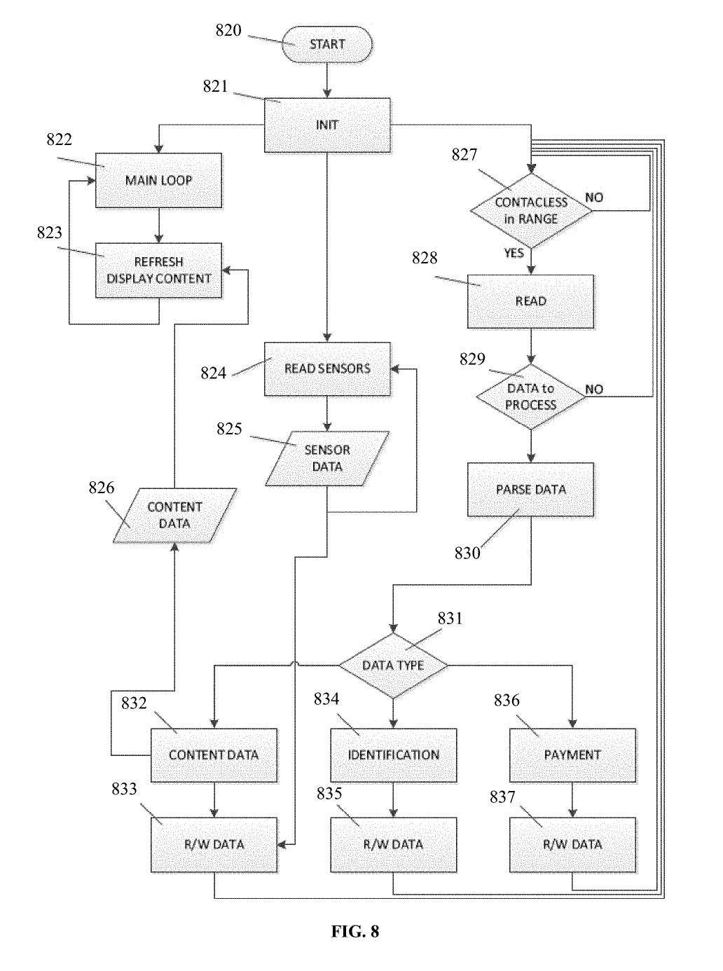

FIG. 8 illustrates a flow chart depicting the steps of a software process for a smart nail, according to an aspect. The process may begin (step 820) when the battery 505 has sufficient power capacity or when enough energy is available from the photovoltaic cell 508, or from a non-contact power source for example. Next, initialization (step 821) may take place, which may include initialization of CPU clocks, timers, input/output ports, communication ports, and the contactless controller and display controller. Next, three loops may be started. The first loop, which may be the main loop (step 822), may cause a display refresh (step 823) on the electronic display 603 of the smart nail 600. The display 603 may continue to refresh, for example, by looping between steps 822 and 823. As an example, the display may alternate images which may include still or video images, or a combination thereof, thus permitting a high degree of customization of smart nail 600. The data related to the content to be displayed (e.g., images) may be stored (step 826) in a local memory (again, not shown in FIG. 6, for drawing clarity) of the smart nail CPU 610, which may, for example, be flash memory.

A second loop may be used for reading biometric sensor data (step 824), which may then store the biometric sensor data into the CPU memory (step 825), which, again, may be a flash memory, for example.

A third loop may be used for managing contactless communication. As an example, if a smart electronic device 717 or any other suitable device having contactless communication features is within range of the smart nail 700 (step 827), contactless communication may be initialized and data may be read by the device 717 and the smart nail 700 (step 828). Next, identification and authorization between the smart electronic device 717 and the smart nail 700 may take place, and if data to be processed is present (step 829), the data may then be parsed and decrypted (step 830). If there is no data to process, the loop may begin again. Next, the software may proceed with determining the type of data that needs to be processed (step 831). If the data is determined to be directed towards content change (step 832), the data may be downloaded from the smart electronic device and stored onto the local memory of the CPU (step 826) to be used by the main loop to refresh the display content. Next, when the download is finished, if data is determined to be sensor data (step 825), the sensor data may be read and/or written and/or uploaded (step 833) to the smart electronic device for further analysis. Other data types may also be recognized (step 831). As examples, other data recognized by the software may be user identification (step 834) to be read or written to the electronic device (step 835) or payment information (step 836) to be read or written to the electronic device (step 837). Required data for user identification and contactless payment may, for example, be stored in a secure section of the local memory of the CPU. Support for any other similar data exchanges may also be available. Running loops may continue as long as sufficient power capacity is available to run the electronic components of the smart nail.

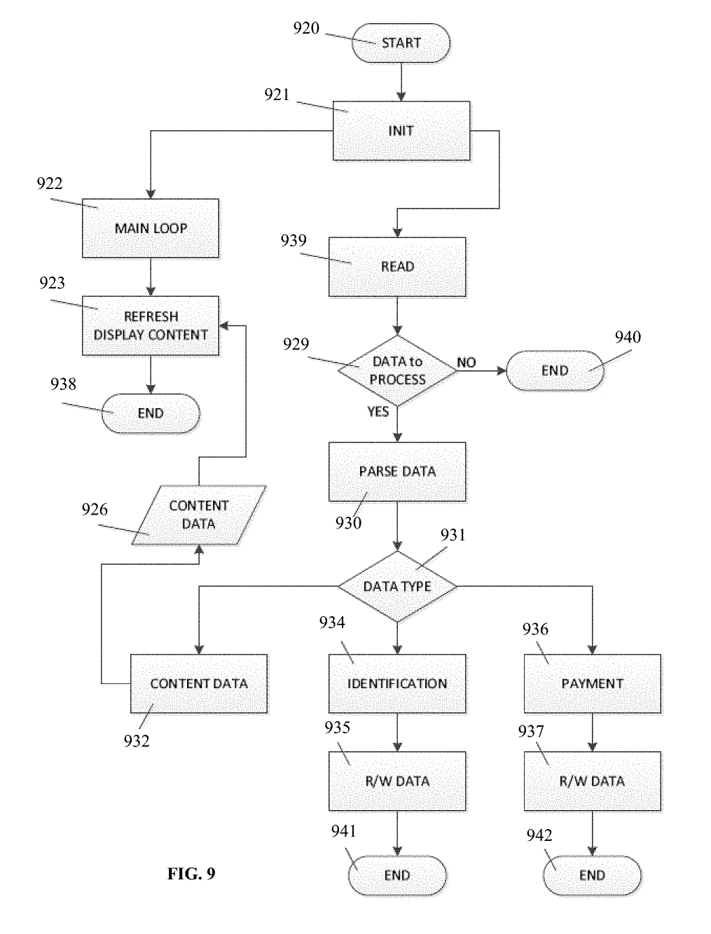

FIG. 9 illustrates a flow chart depicting the steps of a software process for a smart nail without an integrated thin electric battery, according to an aspect. The software program may start (step 920) when the smart nail is within close proximity to a provider of contactless communication which may also provide non-contact power. Next, initialization of several processes may take place (step 921), which may include the initialization of CPU clocks, timers, input/output ports, communication ports, contactless controllers and display controllers. A first loop, which may be a main loop, may start (step 922) and may refresh the content shown on the electronic display of the smart nail (step 923). The main loop may end (step 938) and may begin again (step 922) if another initialization (step 921) takes place. A second loop may also take place (step 939) for the processing of contactless communication between the electronic device and the smart nail. When a smart electronic device or similar device is within range or proximity of the smart nail and contactless communication is taking place, the smart nail may be powered such that data is read (step 939). Next, identification and authorization between the smart electronic device and the smart nail may take place in order to determine whether there is data to be processed (step 929). If not, the second loop may then end (step 940) and may resume (step 939) if another initialization (step 921) takes place. If yes, the data may then be parsed and decrypted (step 930), and next, the software may determine what type the data is (step 931) and how to proceed with the type of data. As an example, if the data is related to content change (step 932), the data may be downloaded from the smart electronic device to be stored onto the local memory of the smart nail (step 926). Next, the main loop (step 922) may detect the new content in the memory of the smart nail and initiate the content refresh step (step 923). The content newly displayed on the smart nail's electronic display may remain displayed even without a power supply until a new loop is initiated, by using for example e-ink technology known in the art, which needs power only to change the content. Again, after the content refresh, the software program may end (step 938). As additional examples of data types, the data types detected by the software (step 931) may be user identification (step 934) which may read by or written to the electronic device (step 935) or payment information (step 936) which may read by or written to the electronic device (step 937). After data exchange is completed, the loops of the program may end (step 941 and step 942).

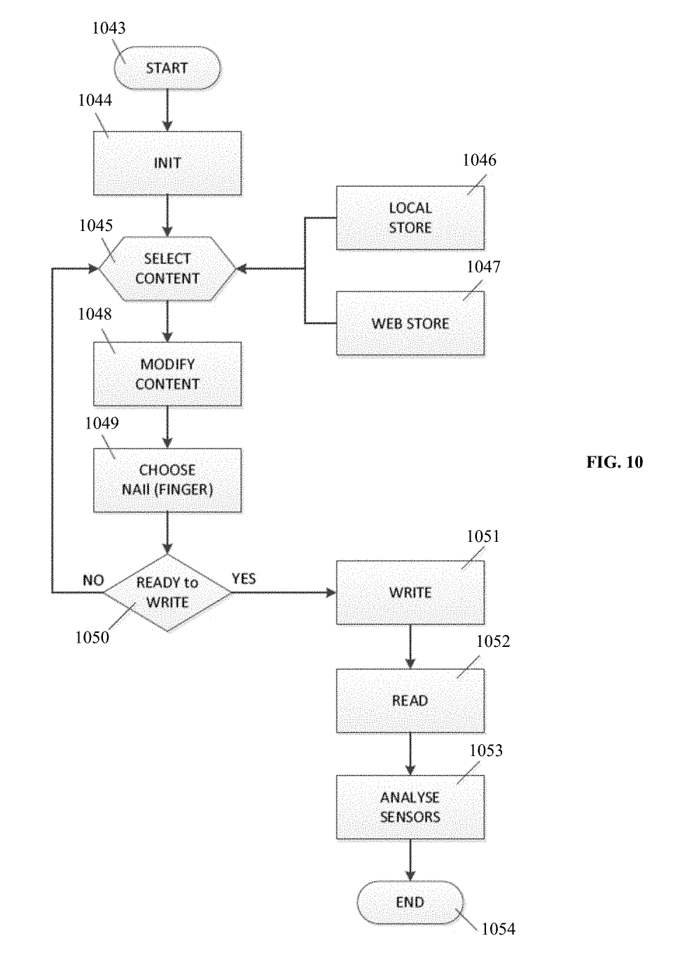

FIG. 10 illustrates a flow chart depicting the steps of a user's experience while using the software of the smart nail, according to an aspect. The user may start the software program (step 1043) by, for example, opening an application (shown by 719 in FIG. 7) on a smart electronic device 717 to begin initialization (step 1044). Next, the initialization step (step 1044) may identify the user and may show the user's history and settings on the application. The user may select content for display on the smart nail 700 (step 1045), which may be from the locally stored content (step 1046) or may be selected from a web store (step 1047), for example. The web store (step 1047) may provide free or paid content to the user. The user may select their content (step 1045) and may make modifications (step 1048), such as, for example, adding text or additional imagery or drawings. Next, the user may assign the content to a specific smart nail or may assign the content to all smart nails (step 1049). The user may be shown a preview of the display of the smart nail on the application and ask the user whether the content is ready to write (step 1050). The application may check if the smart nail is within range such that writing of data can occur. If not, the user may be prompted to move the smart nail into range of the electronic device or may re-select content (step 1045). Next, the user may move the smart nail into close range of the smart electronic device such that contactless communication is established between the smart nail and the device, and the selected content may be downloaded or written to the smart nail (step 1051). Next, any sensor data stored on the smart nail may be read by and written to the smart electronic device (step 1052). Next, the sensor data may be analyzed or stored on the electronic device or uploaded to cloud storage for future analysis (step 1053). Next, the user may close the application to end the program (step 1054).

It may be advantageous to set forth definitions of certain words and phrases used in this patent document.

As used herein and throughout this disclosure, the term “smart electronic device” refers to any electronic device capable of contactless communication (e.g., Near Field Communication (NFC)). A smart electronic device may have a processor, a memory, a transceiver, an input, and an output. Examples of such devices include smartphones, tablet computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, and ROM (read-only memories). A transceiver includes but is not limited to cellular, GPRS, Bluetooth, NFC and Wi-Fi transceivers.

The term “connect” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

1. An artificial electronic nail comprising:
a protective housing having a shape of an artificial nail and having a top transparent housing layer, and a hollow and encapsulated space disposed below the top transparent housing layer and extending between top, side and bottom internal edges of the protective housing; an electronic display disposed within the hollow and encapsulated space and at most extending to the side internal edges of the protective housing, such that, when content is displayed by the electronic display, the content is visible from above the top transparent housing layer, and further, because of the top transparent housing layer acting as a lens, even after a thickness of walls forming the protective housing and extending between the top, side and bottom internal edges and corresponding external edges of the protective housing has been reduced, the content is visible to very external side edges of the protective housing, thus customizing the artificial electronic nail's fit as well as appearance;
a contactless module comprising an antenna and being configured for contactless communication with a smart electronic device;
a biometric sensor;
a battery connected to the electronic display, the biometric sensor and the contactless module;
a central processing unit (CPU) connected to the battery, the contactless module, the electronic display and the biometric sensor and storing processor-executable instructions on a non-transitory processor-readable memory of the CPU that when executed by the CPU enables the artificial electronic nail to perform operations comprising:
detecting that power is available to the CPU;
causing the content to be stored on the memory of the CPU;
causing the content to be displayed via the electronic display;
refreshing the content displayed onto the electronic display;
reading the biometric sensor and storing biometric sensor data on the memory of the CPU;
detecting that the smart electronic device is within a range of contactless communication with the artificial electronic nail;
initiating contactless communication between the smart electronic device and the artificial electronic nail;
allowing the smart electronic device to read the biometric sensor data stored on the memory of the CPU; and
allowing the CPU to write to or download from the smart electronic device artificial electronic nail data.

2. The artificial electronic nail of claim 1 wherein the content displayed by the electronic display is one or more of a color, a hue, a pattern, an image and a video.

3. The artificial electronic nail of claim 1 wherein the artificial electronic nail is configured such that an electromagnetic field from the smart electronic device is used as an electric power supply for changing the content to be displayed via the electronic display.

4. The artificial electronic nail of claim 1 wherein the biometric sensor comprises a body temperature sensor and an infrared (IR) heart rate sensor.

5. The artificial electronic nail of claim 1 having a unique identification number that identifies the artificial electronic nail during contactless communication with the smart electronic device.

6. The artificial electronic nail of claim 1 wherein the artificial electronic nail data is content data for changing the content on the electronic display.

7. The artificial electronic nail of claim 1 wherein the artificial electronic nail data is payment data.

8. The artificial electronic nail of claim 1 wherein the contactless communication is near field communication (NFC).

9. An artificial electronic nail comprising: a protective housing having a shape of an artificial nail and having a top transparent housing layer, and a hollow and encapsulated space disposed below the top transparent housing layer and extending between top, side and bottom internal edges of the protective housing; an electronic display disposed within the hollow and encapsulated space and at most extending to the side internal edges of the protective housing, such that, when content is displayed by the electronic display, the content is visible from above the top transparent housing layer, and further, because of the top transparent housing layer acting as a lens, even after a thickness of walls forming the protective housing and extending between the top, side and bottom internal edges and corresponding external edges of the protective housing has been reduced, the content is visible to very external side edges of the protective housing, thus customizing the artificial electronic nail's fit as well as appearance;
a contactless module comprising an antenna and being configured for contactless communication with a smart electronic device;
a central processing unit (CPU) connected to the contactless module and the electronic display and storing processor-executable instructions on a non-transitory processor-readable memory of the CPU that when executed by the CPU enables the artificial electronic nail to perform operations comprising:
detecting that power is available to the CPU;
causing the content to be stored on the memory of the CPU;
causing the content to be displayed via the electronic display;
detecting that the smart electronic device is within a range of contactless communication with the artificial electronic nail;
initiating contactless communication between the smart electronic device and the artificial electronic nail; and
allowing the CPU to write to or read from the smart electronic device artificial electronic nail data.

10. The artificial electronic nail of claim 9 wherein the content displayed by the electronic display is one or more of a color, a hue, a pattern, an image and a video.

11. The artificial electronic nail of claim 10 wherein the artificial electronic nail is configured such that an electromagnetic field from the smart electronic device is used as an electric power supply for changing the content to be displayed via the electronic display and wherein the content stays displayed even after the electromagnetic field is removed.

12-15. (canceled)
